(19) United States
(12) Patent Application Publication
(10) Pub. No.: US 2009/0150669 A1
(43) Pub. Date: Jun. 11, 2009

(54) METHOD AND APPARATUS FOR PROVIDING DOWNLOADABLE CONDITIONAL ACCESS SERVICE USING DISTRIBUTION KEY

(76) Inventors: Young Ho JEONG, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/188,357

(22) Filed: Aug. 8, 2008

(30) Foreign Application Priority Data
Dec. 6, 2007 (KR) 10-2007-0125955

(51) Int. Cl. H04L 9/00

(52) U.S. Cl. 713/168; 380/277

(57) ABSTRACT

An apparatus and a method for providing a downloadable conditional access service using a distribution key are provided. With regard to the apparatus for providing the downloadable conditional access service using the distribution key, a subscriber authorization system transmits a target entitlement management massage being encoded with a target distribution key to a host, and the host decodes the encoded target entitlement management message being encoded with the target distribution key included in a target secure micro client.

### CROSS-REFERENCE TO RELATED APPLICATION

This application claims priority from Korean Patent Application No. 10-2007-0125955, filed on Dec. 6, 2007, in the Korean Intellectual Property Office, the entire disclosure of which is incorporated herein by reference.

### BACKGROUND OF THE INVENTION

1. Field of the Invention

The present invention relates to a technique for managing and utilizing a distribution key for encoding/decoding an entitlement management message in a downloadable conditional access system.

This work was supported by the IT R&D program of MIC/IITA. [2007-S-007-01, “Development for Downloadable Conditional Access System”]

2. Description of Related Art

When users desire to watch a specific program, a Conditional Access System (CAS) in cable networks determines whether to provide a service based on a user authorization and enables only approved user to receive the program.

In a CAS in an initial stage, each manufacturing company uses standards different from each other, and thus a CAS is not compatible with other devices excluding a device of a particular company. Accordingly, a broadcasting service provider is required to directly provide a receiving terminal to a subscriber, which imposes a heavy burden on a broadcasting service provider and causes a difficulty in updating a CAS.

The OpenCable has provided a standard separating a Conditional Access module from a subscriber terminal to overcome such a disadvantage, that is, to prevent a monopoly of manufacturing company, boost competition, and cause a decline in a product price. Accordingly, a CAS separated from a subscriber terminal is standardized as a cable card of a Personal Computer Memory Card International Association (PCMCIA) card type. Also, a broadcasting service provider provides a subscriber with only cable card without lending a terminal to a subscriber, and thereby may provide a fee-based broadcasting service. However, an expected result of OpenCable has not been achieved due to an increase in a cable card price and management cost as well as failure in a retail market of terminals.

In such a circumstance, a technology related to a downloadable CAS (DCAS) is provided. The DCAS downloads a conditional access software to a subscriber terminal without a separate hardware conditional access module, and thereby enables a fee-based broadcasting service to be provided

According to a general downloadable conditional access system, a host downloads a secure micro client to install the downloaded secure micro client. In this instance, the host should be able to receive an entitlement management message and to decode the received entitlement management message with a distribution key of a most significant key required for performing a CA service. Also, the distribution key should be securely transmitted to the host and effectively managed in the downloadable conditional access system.

However, techniques that can effectively manage the distribution key have not been provided until now. Therefore, a technique that can securely transmit the distribution key to the host and effectively manage the distribution key is required.

### SUMMARY OF THE INVENTION

An aspect of the present invention provides a technique that can securely and effectively utilize and manage a distribution key since a secure micro client installed in a host includes the distribution key and an entitlement management message being encoded with the distribution key is transmitted to the host.

Another aspect of the present invention also provides a technique that can effectively utilize and manage a distribution key since an entitlement management message being encoded with the distribution key which corresponds to a secure micro client is generated based on identification information of the secure micro client.

Another aspect of the present invention also provides a technique that can effectively provide a conditional access service since a distribution key is managed via collaborative operations among a downloadable conditional access system provisioning server (DPS), a subscriber management system, and a subscriber authorization system.

According to an aspect of the present invention, there is provided a method for operating a subscriber authorization system including: maintaining a database that stores distribution keys corresponding to secure micro clients; receiving a target entitlement management message for a target host and identification information of a target secure micro client from a subscriber management system, wherein the target secure micro client including a target distribution key is installed in a target secure micro of the target host; extracting the target distribution key from the stored distribution keys in the database based on the identification information of the target secure micro client; and encoding the target entitlement management message with the extracted target distribution key.

According to another aspect of the present invention, there is provided a method for operating a host using a distribution key including: installing a target secure micro client in a target secure micro of a target host, the target secure micro including a target distribution key; receiving a target entitlement management message which is encoded with the target distribution key from a subscriber authorization system; and decoding the encoded target entitlement management message with the target distribution key included in the target secure micro client.

According to still another aspect of the present invention, there is provided a method for operating a subscriber management system including: receiving identification information of a target secure micro and identification information of a target secure micro client from a DPS, wherein the target secure micro client including a target distribution key is established in the target secure micro of a target host; generating a target entitlement management message for the target host based on the identification information of the target secure micro and the identification information of the target secure micro client; and sending the target entitlement management message and the identification information of the target secure micro client to the subscriber authorization system, and wherein the subscriber authorization system sends the target entitlement management message which is encoded with the target distribution key to the target host.

According to a further aspect of the present invention, there is provided a method for operating a DPS including: maintaining a database that stores identification information of secure micro clients; extracting identification information of a target secure micro client from the identification information of the secure micro clients based on identification information of the target secure micro being obtained from an authorization proxy server, wherein the target secure micro client is established in a target secure micro of a target host; and sending the identification information of the target secure micro and the identification information of the target secure micro clients to a subscriber authorization system, and wherein the subscriber authorization system sends a target entitlement management message corresponding to the target secure micro client, encoded with the target distribution key, to the target host.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a diagram illustrating a downloadable conditional access system, a billing system, a conditional access service server, and a host according to an exemplary embodiment of the present invention;

FIG. 2 is a diagram illustrating identification information of a secure micro client and identification information of a secure micro which are managed in a downloadable conditional access system provisioning server (DPS) according to an exemplary embodiment of the present invention;

FIG. 3 is a diagram illustrating information about a subscriber managed in a subscriber management system and information provided from a downloadable conditional access system provisioning server (DPS) according to an exemplary embodiment of the present invention;

FIG. 4 is a diagram illustrating identification information of a secure micro client and a distribution key managed in a subscriber authorization system according to an exemplary embodiment of the present invention; and

FIG. 5 is a flowchart illustrating a method for managing and utilizing a distribution key in a host, a subscriber management system, and a subscriber authorization system according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

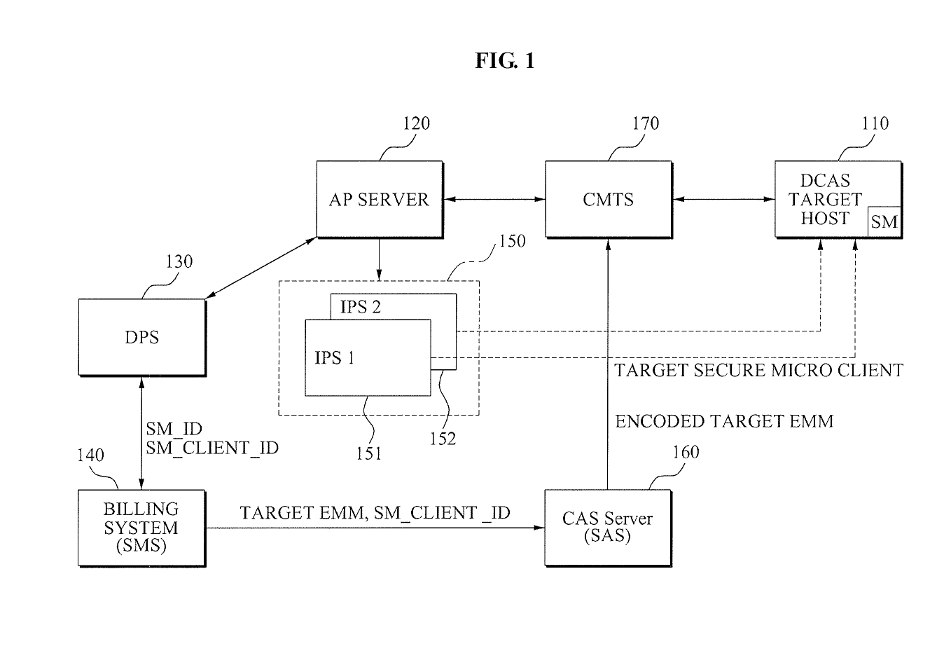

FIG. 1 is a diagram illustrating a downloadable conditional access system, a billing system, a server, and a host according to an exemplary embodiment of the present invention.

Referring to FIG. 1, a downloadable conditional access system target host 110 (hereinafter, this is referred to as “target host”) may perform mutual authentication with an authentication proxy server (AP) 120 via various protocols. In this instance, although it is not illustrated in FIG. 1, the target host 110 may perform mutual authentication with the AP 120 via reliable external authentication apparatuses.

During the performing of mutual authentication, the AP 120 transmits identification information of a target secure micro(SM_ID) included in the target host 110 to a downloadable conditional access system provisioning server (DPS) 130.

Also, the DPS 130 maintains to manage a database storing identification information of each of a plurality of secure micro clients. Namely, the identification information of each of the plurality of secure micro clients is stored in the database in advance.

In this instance, the DPS 130 receives identification information of the target secure micro (SM_ID), and selects a target secure micro client, which is downloaded to the target host 110, from among the plurality of secure micro clients based on the stored identification information of the plurality of secure micro clients. Specifically, the identification information of the target secure micro (SM_ID) and the identification information of the target secure micro client (SM_Client_ID) are mapped with each other.

The DPS 130 commands an integrated personalization system 150 to perform a necessary process in order to download the target secure micro client to the target host 110 via the AP 120. Specifically, any one of an integrated personalization system (IPS) 1 151 or an integrated personalization system (IPS) 2 152 downloads the target secure micro client to the target host 110 via any one of various transmission schemes such as a trivial file transfer protocol (TFTP), a hypertext transfer protocol (HTTP), a broadcast carousel, and the like.

In this instance, the target secure micro client includes a distribution key for encoding/decoding a target entitlement management message. That is, although it will be described below, the target host 110 may decode the target entitlement management message, being encoded with the distribution key, with the distribution key included in the target secure micro client.

Also, when the target secure micro client is successfully downloaded to be installed in the target secure micro of the target host 110, the DPS 130 receives a confirmation message from the AP 120 confirming that the target secure micro client is successfully installed. The DPS 130 transmits the identification information of the mapped target secure module (SM_ID) and the identification information of the target secure micro client (SM_Client_ID) to the billing system 140, in response to the received confirmation message. In this instance, the billing system 140 includes a subscriber management system (SMS).

In this instance, the SMS generates a plurality of entitlement management messages corresponding to each of a plurality of subscribers according to joins and changes of the subscribers, and stores the generated entitlement management messages. The subscriber management system may generate the entitlement management messages based on information about the subscribers being stored in advance, such as personal information about the subscriber, a service type the subscriber applied for, identification information of a secure micro owned by the subscriber, and the like.

The subscriber management system may select a target entitlement management message (EMM) corresponding to the target secure micro client from among the plurality of entitlement management messages based on the identification information of the target secure module (SM_ID) and the identification information of the target secure micro client (SM_Client_ID) being received from the DPS 130.

In this instance, the subscriber management system may transmit the selected target EMM and the identification information of the target secure micro client (SM_Client_ID) to a conditional access service server 160. The conditional access service server 160 includes the subscriber authorization system (SAS).

The SAS stores distribution keys corresponding to each of the plurality of secure micro clients and the identification information of the plurality of secure micro clients in advance. It is described in the specification of the present invention that a single secure micro client corresponds to a single distribution key, however the idea of the present invention may also be applied to a case that at least two secure micro clients correspond to an identical distribution key.

Also, the SAS extracts a target distribution key corresponding to the target secure micro client from distribution keys based on the identification information of the target secure micro client (SM_Client_ID) being received from the SMS. The SAS encodes the target EMM with the extracted target distribution key, and transmits the encoded target EMM to the target host 110 via a cable modem termination system 170 (CMTS).

In this instance, the target secure micro client is installed in the target host 110, and the target secure micro client includes the target distribution key. Therefore, the target host 110 may decode the encoded target EMM, encoded with the target distribution key, with the distribution key included in the target secure micro client.

The target host 110 may extract a code word by decoding the encoded target EMM and an entitlement control message. In this instance, the target host 110 may decode broadcast contents with the extracted code word.

According to an embodiment of the present invention, the target host 110 can securely obtain the target distribution key without performing an additional operation, and decode the target EMM with the obtained target distribution key. Further to this, since the target secure micro client is generally downloaded to be installed in the target host 110 according to a strict protocol and the target secure micro client includes the target distribution key, according to the present invention, the target distribution key is securely and effectively can be provided to the target host 110.

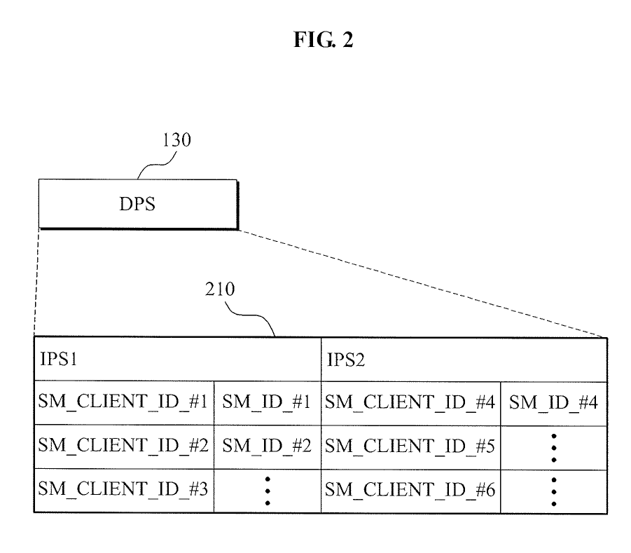

FIG. 2 is a diagram illustrating identification information of a secure micro client and identification information of a secure micro which are managed in a downloadable conditional access system provisioning server (DPS) 130 according to an exemplary embodiment of the present invention.

Referring to FIG. 2, the DPS 130 stores identification information of a plurality of secure clients being stored in each of an integrated personalization system (IPS) 1 151 and an integrated personalization system (IPS) 2 152 in a table 210.

The DPS 130 stores identification information of a secure micro client 1 (SM_Client_ID_#1), identification information of a secure micro(SM) client 2 (SM_Client_ID_#2), and identification information of a SM client 3 (SM_Client_ID_#3), included in the IPS 1 151, in the table 210 in advance. Also, the DPS 130 stores identification information of a SM client 4 (SM_Client_ID_#4), identification information of a SM client 5 (SM_Client_ID_#5), and identification information of a SM client 6 (SM_Client_ID_#6), included in the IPS 2 152, in the table 210 in advance.

Also, the DPS 130 stores identification information of the secure micro 1 (SM_ID_#1), identification information of the secure micro 2 (SM_ID_#2), and identification information of the secure micro 4 (SM_ID_#4), performed mutual authentication with an authentication proxy server, in the table 210. That is, the DPS 130 performs mapping with respect to the identification information of the SM clients (SM_Client_ID_#1), (SM_Client_ID_#2), (SM_Client_ID_#3), (SM_Client_ID_#4), (SM_Client_ID_#5), and (SM_Client_ID_#6) and the identification information of the secure micros (SM_ID_#1), (SM_ID_#2), and the secure micro (SM_ID_#4), which have completed mutual authentication with the authentication proxy server, and stores the mapped identification information of the secure micro clients and the secure micros in the table 210.

In this instance, the DPS 130 transmits the mapped identification information of the secure micro clients (SM_Client_ID_#1), (SM_Client_ID_#2), (SM_Client_ID_#3), (SM_Client_ID_#4), (SM_Client_ID_#5), and (SM_Client_ID_#6) and secure micros (SM_ID_#1), (SM_ID_#2), and the secure micro (SM_ID_#4) to a subscriber management system. In this instance, the subscriber management system generates an entitlement management message based on the mapped identification information of the secure micro clients and the secure micros.

As an example, the DPS 130 may transmit identification information of the secure micro client 2 (SM_Client_ID_#2) and identification information of the secure micro 2 (SM_ID_#2) to the subscriber management system. The subscriber management system generates an entitlement management message corresponding to the identification information of the secure micro client 2 (SM_Client_ID_#2) based on the identification information of the secure micro client 2 (SM_Client_ID_#2) and the identification information of the secure micro 2 (SM_ID_#2), and transmits the generated entitlement management message and the identification information of the secure micro client 2 (SM_Client_ID_#2) to the subscriber authorization system. The subscriber authorization system extracts a distribution key corresponding to the identification information of the secure micro client 2 (SM_Client_ID_#2) based on the identification information of the secure micro client 2 (SM_Client_ID_#2), and encodes the entitlement management message with the extracted distribution key.

In this instance, since a secure micro client 2 is installed in a secure micro of a host and the secure micro client 2 includes the distribution key, the host may decode the encoded entitlement management message.

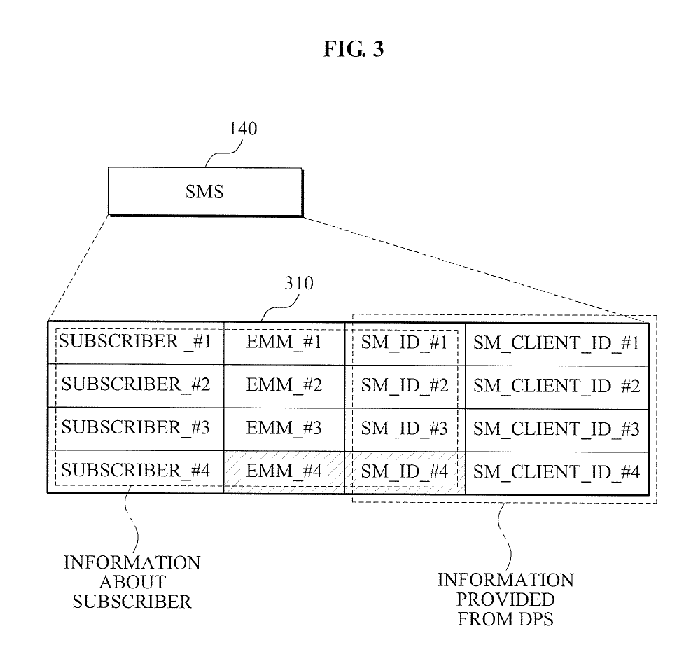

FIG. 3 is a diagram illustrating information about a subscriber managed in a subscriber management system (SMS) 140 and information provided from a DPS according to an exemplary embodiment of the present invention.

Referring to FIG. 3, the SMS 140 stores the information about the subscriber in a table 310 in advance. The information about the subscriber includes personal information about the subscriber, a service type the subscriber applied for, identification information of a secure micro the subscriber uses, and an entitlement management message corresponding to a service subscriber.

Also, the SMS 140 receives identification information of secure micro clients and identification information of secure micros from a downloadable conditional access system provisioning server (DPS). The subscriber management system searches for the received identification information of the secure micros from the table 310, and performs mapping with respect to the information about the subscriber being stored in advance, the identification information of the secure micro clients, and secure micros being received from the DPS.

Therefore, the SMS 140 may generate an entitlement management message corresponding to the received identification information of the secure micros. As an example, the SMS 140 selects an EMM_#4 to be a target entitlement management message of a target host when the SMS 140 receives an SM_IP_#4 from the DPS.

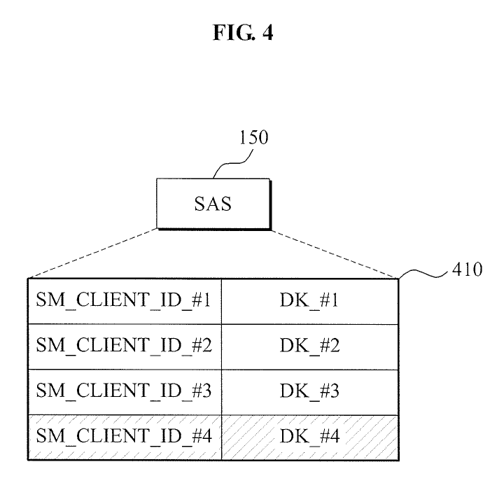

FIG. 4 is a diagram illustrating identification information of a secure micro client and a distribution key managed in a subscriber authorization system according to an exemplary embodiment of the present invention.

Referring to FIG. 4, a subscriber authorization system 150 stores identification of a plurality of secure micro clients and a plurality of distribution keys in a table 410 in advance.

The subscriber authorization system 150 receives a target entitlement management message from a subscriber management system and identification information of a target secure micro client. In this instance, the subscriber authorization system extracts a distribution key corresponding to a target secure micro client based on the received identification information of the target secure micro client

Specifically, the subscriber authorization system 150 may receive an SM_Client_ID_#4 and the EMM_#4 of FIG. 3. In this instance, the subscriber authorization system 150 extracts a distribution key DK_#4 corresponding to the SM_Client_ID_#4 based on the SM_Client_ID_#4, and the subscriber authorization system 150 encodes the EMM_#4 with the extracted distribution key DK_#4.

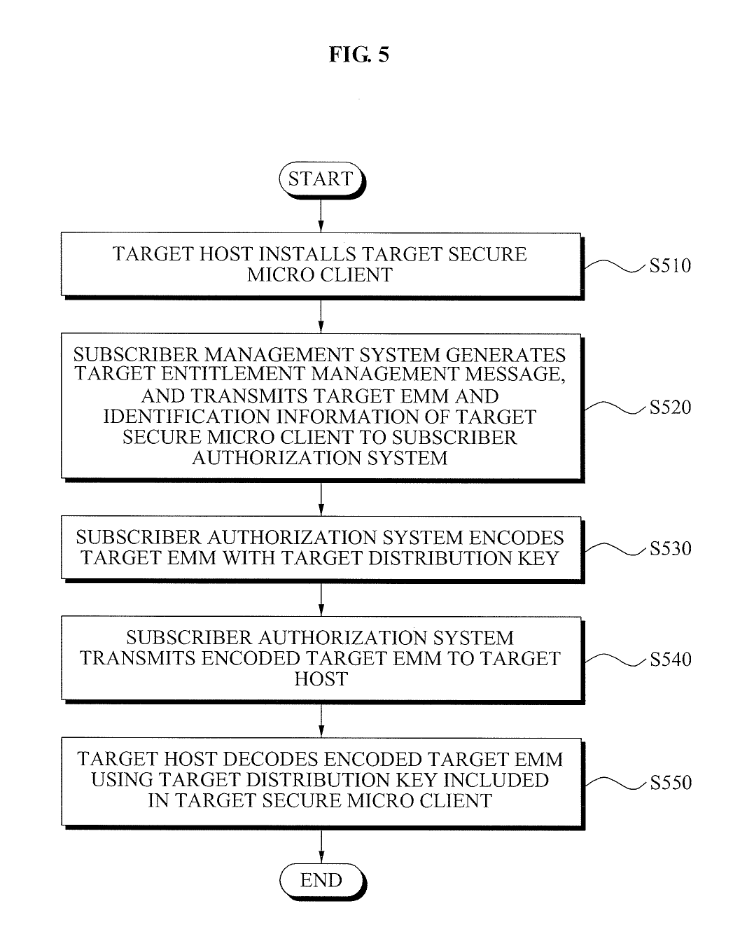

FIG. 5 is a flowchart illustrating a method for managing and utilizing a distribution key in a host, a subscriber management system, and a subscriber authorization system according to an exemplary embodiment of the present invention.

Referring to FIG. 5, in operation S510, a target host installs a target secure micro client. In this instance, the target secure micro includes a target distribution key for encoding/decoding a target entitlement management message.

In operation S520, the subscriber management system generates the target entitlement management message, and transmits the target entitlement management message and identification information of a target secure micro client to the subscriber authorization system.

In operation S530, the subscriber authorization system extracts a target distribution key with the identification information of the target secure micro client, and encodes the target entitlement management message with the extracted target distribution key.

In operation S540, the subscriber authorization system transmits the encoded target entitlement management message to the target host.

In operation S550, the target host decodes the encoded target entitlement management message with the target distribution key included in the target secure micro client.

The method for managing and utilizing a distribution key in a host, a subscriber management system, a subscriber authorization system according to the above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, it is possible to securely and effectively utilize and manage a distribution key since a secure micro client installed in a host includes the distribution key and an entitlement management message being encoded with the distribution key is transmitted to the host.

According to the present invention, it is possible to effectively utilize and manage a distribution key since an entitlement management message being encoded with the distribution key corresponding to a secure micro client is generated based on identification information of the secure micro client.

According to the present invention, it is possible to effectively provide a conditional access service since a distribution key is managed via collaborative operations among a downloadable conditional access system provisioning server (DPS), a subscriber management system, and a subscriber authorization system.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for managing a subscriber authorization system using a distribution key, the method comprising:
maintaining a database that stores distribution keys corresponding to secure micro clients;
receiving a target entitlement management message for a target host and identification information of a target secure micro client from a subscriber management system, wherein the target secure micro client including a target distribution key is installed in a target secure micro of the target host;
extracting the target distribution key from the stored distribution keys in the database based on the identification information of the target secure micro client; and
encoding the target entitlement management message with the extracted target distribution key.

2. The method of claim 1, wherein the maintaining of the database maintains the database that stores separately the distribution keys based on the identification information of the secure micro clients.

3. The method of claim 1, wherein the subscriber management system receives identification information of the target secure micro and the identification information of the target secure micro client, and generates the target entitlement management message and the identification information of the target secure micro client based on the identification information of the target secure micro.

4. The method of claim 3, wherein the subscriber management system verifies whether the target host joins a service or not to generate the target entitlement management message.

5. The method of claim 1, further comprising:
sending the encoded target entitlement management message to the target host.

6. The method of claim 5, wherein the target host decodes the encoded target entitlement management message based on the target distribution key included in the target secure micro clients.

7. A method for operating a host using a distribution key, the method comprising:
installing a target secure micro client in a target secure micro of a target host, the target secure micro including a target distribution key;
receiving a target entitlement management message which is encoded with the target distribution key from a subscriber authorization system; and
decoding the encoded target entitlement management message with the target distribution key included in the target secure micro client.

8. The method of claim 7, further comprising:
decoding the encoded target entitlement management message to extract a control word, and decoding encoded broadcast contents with the extracted code word.

9. The method of claim 7, wherein the subscriber authorization system receives identification information of the target secure micro client and the target entitlement management message from the subscriber authorization system, extracts the target distribution key based on the identification information of the target secure micro client, and encodes the target entitlement management message with the extracted target distribution key.

10. The method of claim 9, wherein the subscriber management system generates the identification information and the target entitlement management message of the target secure micro client based on identification information of the target secure micro or the identification information of the target secure micro client being received from a downloadable conditional access system provisioning server (DPS).

11. A method for operating a subscriber management system, the method comprising:
receiving identification information of a target secure micro and identification information of a target secure micro client from a DPS, wherein the target secure micro client including a target distribution key is established in the target secure micro of a target host;
generating a target entitlement management message for the target host based on the identification information of the target secure micro and the identification information of the target secure micro client; and
sending the target entitlement management message and the identification information of the target secure micro client to the subscriber authorization system, and
wherein the subscriber authorization system sends the target entitlement management message which is encoded with the target distribution key to the target host.

12. The method of claim 11, wherein the generating of the target entitlement management message verifies whether the target host joins a service or not to generate the target entitlement management message.

13. The method of claim 11, wherein the generating of the target entitlement management message generates the target entitlement management message based on entitlement management messages which are stored in advance.

14. The method of claim 11, wherein the target host decodes the target entitlement management message, encoded by the target distribution key, with the target distribution key included in the target secure micro client.

15. The method of claim 11, wherein the subscriber authorization system selects the target distribution key from a plurality of distribution keys which are stored in advance based on the identification information of the target secure micro client, and generates the encoded target entitlement management message based on the selected target distribution key.

16. A method for operating a downloadable conditional access system provisioning server (DPS), the method comprising:
maintaining a database that stores identification information of secure micro clients;
extracting identification information of a target secure micro client from the identification information of the secure micro clients based on identification information of the target secure micro being obtained from an authentication proxy server, wherein the target secure micro client is established in a target secure micro of a target host; and
sending the identification information of the target secure micro and the identification information of the target secure micro clients to a subscriber authorization system, and wherein the subscriber authorization system sends a target entitlement management message corresponding to the target secure micro client, encoded with the target distribution key, to the target host.

17. The method of claim 16, wherein the target host decodes the target entitlement management message which is encoded with the target distribution key based on the target distribution key included in the target secure micro clients.

18. The method of claim 16, wherein the subscriber management system selects the target entitlement management message from among entitlement management messages which are stored based on the identification information of the target secure micro in advance and the identification information of the target secure micro clients.

19. The method of claim 16, wherein the subscriber authorization system extracts the target distribution key based on the identification information of the target secure micro client from among pre-stored the distribution keys, and sends the target entitlement management message, encoded with the extracted target distribution key, to the target host.
